(19) United States
(12) Patent Application Publication
(10) Pub. No.: US 2020/0259667 A1
(43) Pub. Date: Aug. 13, 2020

(54) DISTRIBUTED MANAGEMENT SYSTEM FOR REMOTE DEVICES AND METHODS THEREOF

(71) Applicant: Arm Limited, Cambridge (GB)

(72) Inventors: Donatien Marie Pierre-Yves M GARNIER, Cambridge, Cambridgeshire (GB); Jerome Yi-Zhe JOAUG, Cambridge, Cambridgeshire (GB)

(21) Appl. No.: 16/647,988

(22) PCT Filed: Nov. 23, 2018
(86) PCT No.: PCT/GB2018/053392

§ 371 Date: Mar. 17, 2020

(30) Foreign Application Priority Data
Nov. 23, 2017 (GB) 1719472.1

(51) Int. Cl. H04L 9/32; H04L 29/06; H04W 12/06; H04L 12/66; H04L 29/08

(52) U.S. Cl. CPC H04L 9/3263; H04L 9/321; H04L 63/08; H04L 63/105; G16Y 40/50; H04W 12/0609; H04L 12/66; H04L 67/12; H04L 63/1416

(57) ABSTRACT

Disclosed is a method for a gateway device to obtain management control of an Internet of Things device. The Internet of Things device including a data store stores a private key of a private/public key pair for the Internet of Things device. Moreover, the data store stores a digital certificate for a root of trust. Furthermore, the data store stores a device digital certificate signed by a root of trust. Moreover, the method comprises connecting the gateway device to a security entity to obtain a gateway device digital certificate, signed by the root of trust, and permission to perform tasks on the Internet of Things device. Furthermore, the method comprises connecting the gateway device to the Internet of Things device; and using the Internet of Things device's public key and the gateway device digital certificate to obtain management control of the Internet of Things device.

### TECHNICAL FIELD

The present disclosure relates generally to remote device management; and more specifically, to methods and systems for the management of remote devices such as Internet of Things (IoT) devices.

### BACKGROUND

With the recent development of machine-to-machine communication the connectivity of physical objects has increased. Such development, has improved the accessibility of objects in our day to day lives. Currently, the Internet of Things provides a network where physical objects are readable, recognizable, locatable, addressable, and controllable. The Internet of Things includes wearables, connected cars, connected homes, connected cities, and industrial Internet/networks. Typically, the Internet of Things can quickly generate large amount of data that can be used to improve lives of both individuals and groups/organizations.

However, the conventional Internet of Things networks include certain difficulties when implemented. A common problem in the conventional Internet of Things network is data connectivity. In the conventional Internet of Things networks, plurality of Internet of Things devices are connected to a server, that is the operable to control and manage all the Internet of Things devices from a remote location. In such architecture, the data connectivity between the server and the plurality of Internet of Things devices is often interrupted for various reasons, such as lack of data connectivity due to bad weather, faulty connecting hardware and so forth. Furthermore, in the conventional Internet of Things networks, the network components such as the plurality of Internet of Things devices and the servers are dependent on each other, i.e. if a network component shuts down the entire network may collapse or the data connectivity is disrupted. Another common problem in the conventional Internet of Things network is data security. Furthermore, the conventional Internet of Things network is often vulnerable to potential cyber-attacks. Additionally, as the Internet of Things network mostly transmits confidential data; the vulnerability to potential cyber-attacks increases the challenges in implementing the conventional Internet of Things networks.

Therefore, in light of the foregoing discussion, there exists a need to overcome the aforementioned drawbacks associated with management of the Internet of Things devices.

### SUMMARY

The present disclosure seeks to provide a method for a gateway device or user of a gateway device to obtain management control of an Internet of Things device.

The present disclosure also seeks to provide a distributed management system for Internet of Things devices, comprising multiple Internet of Things devices and a plurality of gateway devices, each gateway device being configured to manage a plurality of the Internet of Things devices.

The present disclosure also seeks to provide a gateway device for managing Internet of Things devices.

The present disclosure also seeks to provide a method for the management of Internet of Things devices, performed at a gateway device.

According to a first aspect, there is provided a method for a gateway device, or user of a gateway device, to obtain management control of an Internet of Things device, the Internet of Things device including a data store storing:
a private key of a private/public key pair for the Internet of Things device;
a digital certificate from a root of trust;
a gateway device, or gateway device user, digital certificate signed by the root of trust, the method comprising:
connecting the gateway device to a security entity to obtain a gateway device, or gateway device user, digital certificate, signed by the root of trust, and permission to perform tasks on the Internet of Things device;
connecting the gateway device to the Internet of Things device; and
using the gateway device's, or gateway device user's, digital certificate to obtain management control of the Internet of Things device.

The present disclosure seeks to provide a solution to the existing problem of managing the Internet of Things devices; moreover, the present disclosure seeks to provide management control of an Internet of Things device.

Optionally, the security entity comprises a server. More optionally, the security entity is the root of trust. Yet more optionally, the security entity comprises a Subscriber Identity Module card. Optionally, the security entity is shared with other gateway devices

More optionally, the permissions include permission to modify firmware of the Internet of Things device.

Yet more optionally, after obtaining control of the Internet of Things device, using the gateway device to modify firmware of the Internet of Things device.

Optionally, the gateway device receives permissions from the security entity to control multiple Internet of Things devices.

More optionally, taking control of multiple Internet of Things devices using for each of the multiple Internet of Things devices the gateway device digital certificate.

Optionally, connecting the gateway device to the Internet of Things device is by means of LPWAN or a wireless personal area network technology.

Optionally, the server comprises an identity access management server configured to establish the authentication of a user of the gateway device and a secure device access server configured to establish an authorisation of the user of the gateway device to communicate with Internet of Things devices via the gateway device.

Optionally, the authorisation of the user of the gateway device established by the secure device access server provides a first level of authorisation allowing reboot of the Internet of Things devices.

Optionally, the authorisation of the user of the gateway device established by the secure device access server provides a second level of authorisation allowing a firmware update of the Internet of Things devices.

Optionally, the data store of the Internet of Things device further stores event data relating, at least, to tasks performed at the Internet of Things device.

Optionally, the event data is signed by the Internet of Things device.

Optionally, the server receives, from the gateway device, event data relating to Internet of Things devices controlled by the gateway device, replays the tasks at the server, compares the replayed tasks to the received event data and identifies a malicious attack if the replayed tasks do not match the received event data.

According to a second aspect, there is provided a distributed management system for Internet of Things devices, comprising multiple Internet of Things devices and a plurality of gateway devices, each gateway device being configured to manage a plurality of the Internet of Things devices, and each Internet of Things device and each gateway device having:
its own private/public key pair;
a data store storing its own private key and a digital certificate signed by a root of trust; wherein the digital certificates are all signed by a common root of trust; and wherein
the data store of each gateway device stores addresses of each of the Internet of Things devices that it manages, and the data store of each Internet of Things device stores a digital certificate of the common root of trust.

Optionally, each gateway device is authorised by the root of trust to perform tasks on the Internet of Things devices that it manages. More optionally, for each gateway device the digital certificate signed by the root of trust indicates the tasks that the gateway device is authorised to perform on the Internet of Things devices that it manages.

Yet more optionally, one of the plurality of gateway devices provides a master clock to which the Internet of Things devices and other gateway devices are synchronised.

Optionally, the data store of each gateway device records tasks performed on, and data provided by the Internet of Things devices that it manages.

According to a third aspect, there is provided a gateway device for managing Internet of Things devices, the gateway device comprising:
an interface for connection to a security entity;
a data store;
a device interface for connection to one or more Internet of Things devices; and
a processing means, wherein the processing means of the gateway device being configured to:
   establish through the interface the connection to the security entity;
   receive security credentials over the connection from the security entity;
   receive from the security entity an assignment of tasks for the gateway device to perform on one or more Internet of Things devices;
   establish through the device interface a data connection with the one or more Internet of Things devices;
   use the received security credentials to obtain control of the one or more Internet of Things devices;
   perform assigned tasks on the one or more Internet of Things devices asynchronously;
   receive from the one or more Internet of Things devices, over a data connection, event data relating to the one or more Internet of Things devices; and
   store the received event data in the data store.

According to a fourth aspect, there is provided a method for the management of Internet of Things devices, performed at a gateway device, the method comprising:
establishing a data connection between the gateway device and a security entity;
receiving security credentials from the security entity over the data connection;
the security credentials authorizing the gateway device, or user of the gateway device, to perform management of Internet of Things devices;
receiving an assignment of tasks to be performed on Internet of Things devices;
establishing a local network connection between the gateway device and an Internet of Things device;
using the received security credentials to establish a secure relationship between the gateway device and the Internet of Things device;
performing assigned tasks on the Internet of Things device asynchronously;
receiving from the Internet of Things device, over the local network connection, event data relating to the Internet of Things device;
and
storing the received event data in a data store.

It will be appreciated that features of the present disclosure are susceptible to being combined in various combinations without departing from the scope of the present disclosure as defined by the appended claims.

### BRIEF DESCRIPTION OF THE DRAWINGS

Embodiments of the present disclosure will now be described, by way of example only, with reference to the following diagrams wherein:

FIG. 1 is a block diagram of a distributed management system for Internet of Things device, in accordance with different embodiment of the present disclosure;

FIG. 2 is an illustration of steps of a method for a gateway device to obtain management control of an Internet of Things device, in accordance with different embodiment of the present disclosure; and

FIG. 3 is an illustration of steps of a method for the management of Internet of Things devices, performed at a gateway device, in accordance with different embodiment of the present disclosure.

FIG. 4 is a block diagram of an architecture for control of Internet of Things devices, in accordance with different embodiments of the present disclosure.

FIG. 5 is an illustration of communications between a gateway device and an Internet of Things device according to embodiments of the disclosure.

FIG. 6 is a flow chart of a verification process at a server arrangement according to embodiments of the disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

In overview, embodiments of the present disclosure are concerned with management control of an Internet of Things device.

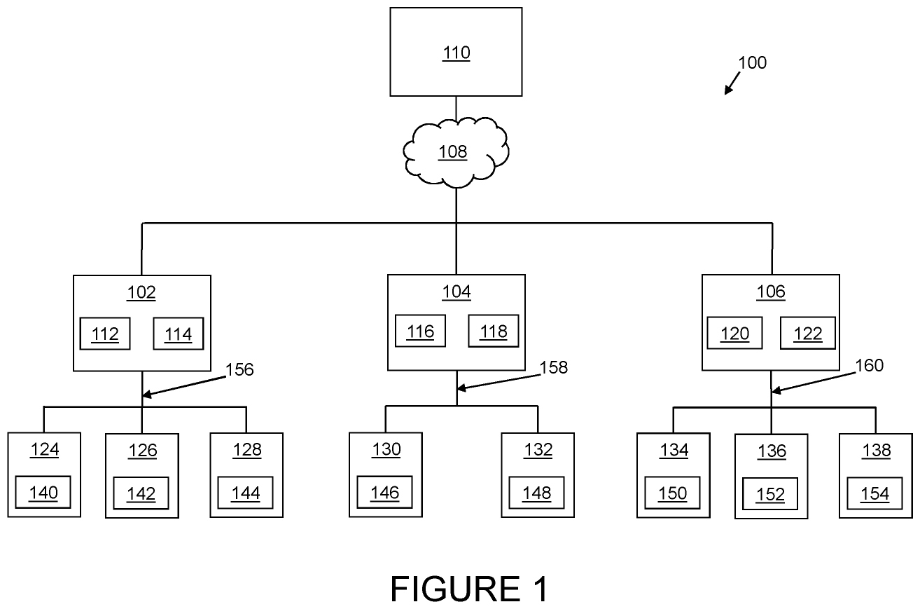

Referring to FIG. 1, there is shown a block diagram of a distributed management system 100 for Internet of Things device, in accordance with different embodiment of the present disclosure. The system 100 includes plurality of gateway devices 102-106, an interface 108, a security entity 110, and multiple Internet of Things devices 124-138. As shown, the gateway devices 102-106 include data stores 112, 116 and 120, and processing means 114, 118, and 122. Furthermore, the gateway device 102 coupled with multiple Internet of Things devices 124-128 via a device interface 156, the gateway device 104 coupled with multiple Internet of Things devices 130-132 via a device interface 158, and the gateway device 106 coupled with multiple Internet of Things devices 134-138 via a device interface 160. Furthermore, the Internet of Things device 124-138 includes data stores 140-154.

The present disclosure provides a distributed management system 100 for Internet of Things devices. Throughout the present disclosure, the term “distributed management system” relates to a structure and/or module including programmable and/or non-programmable components that are arranged in a manner to form a distributed computing environment. Optionally, the programmable and/or non-programmable components arranged in such distributed computing environment are configured to store, process and/or share information therein. The distributed management system 100 is a digital environment that allows seamless management of the Internet of Things devices. Additionally, the distributed management system 100 is capable of managing the Internet of Things devices in a manner that is safe, fast, and comparatively cost-effective.

The distributed management system 100 for Internet of Things devices, comprising multiple Internet of Things devices 124-138 and a plurality of gateway devices 102-106. Throughout the present disclosure, the term “Internet of Things devices” relates to electronic devices that are configured to transmit data related to a specific function performed by the device. Optionally, the Internet of Things devices 124-138 are devices that are configured to include an addressable interface that can be used to transmit information to one or more other devices (such as the gateway device and/or the Internet of Things devices) over at least one wired and/or wireless connection. Optionally, the addressable interface includes one or more of the, but is not limited to, media access control (MAC) address, BT MAC, LoraWAN address, Internet Protocol (IP) address, Bluetooth identifier (ID), near-field communication (NFC) identifier (ID), and the likes. Optionally, the Internet of Things devices 124-138 are configured to establish communication with one or more gateway devices (such as the gateway devices 102-106) using various communication mechanisms, such as, NFC polling, BLE discovery, mDNS/Bonjour, QR codes, barcodes and the likes. Optionally, the Internet of Things devices 124-138 may include smart home controller, router, fire alarm, security camera, fitness tracker, speaker, television, gaming console, PC, laptop, tablet, thermostat, furnace, air conditioner, heat pump, hot water heater, light, alarm system, appliance (e.g., refrigerator, oven, stove, dishwasher, washing machine, dryer, microwave oven, etc.), sensor, lawn mower, vehicle, head-mounted display, clothing, and so forth. Throughout the present disclosure, the term “gateway device” relates to an electronic device that is capable of performing specific tasks associated with the distributed management system 100, such as performing management control of the multiple Internet of Things devices 124-138. Furthermore, the gateway devices 102-106 are intended to be broadly interpreted to include any electronic device that may be used for data communication over a wireless communication network. Examples of the gateway devices 102-106 includes, but are not limited to, cellular phones, personal digital assistants (PDAs), handheld devices, wireless modems, laptop computers, personal computers, embedded computers, and so forth. Optionally, the gateway devices 102-106 are implemented as any one of a mobile station, a mobile terminal, a subscriber station, a remote station, a user terminal, a subscriber unit, an access terminal, and suchlike. Optionally, each of the gateway devices of the plurality of gateway devices 102-106, includes a casing, a memory, a processor, a network interface card, a microphone, a speaker, a keypad, a display and so forth. Optionally, the gateway devices 102-106 is to be construed broadly, so as to encompass a variety of different types of mobile stations, subscriber stations or, more generally, communication devices, including examples such as a combination of a data card inserted in a laptop. Such communication devices are also intended to encompass devices commonly referred to as access terminals. According to the present disclosure, each of the gateway devices 102-106 is configured to manage a plurality of the Internet of Things devices 124-138. Optionally, the gateway device 102 is operable to control the Internet of Things devices 124, 126 and 128, the gateway device 104 is operable to control the Internet of Things devices 130 and 132, and the gateway device 106 is operable to control the Internet of Things devices 134, 136 and 138.

According to the present disclosure, each of the Internet of Things devices 124-138 and each gateway devices 102-106 include its own private/public key pair. Optionally, any one gateway device of the plurality of gateway devices 102-106 and any one Internet of Things device of the multiple Internet of Things devices 124-138 is configured to use asymmetric cryptography system to facilitate secure communication therein. Optionally, the asymmetric cryptographic system is operable to generate a pair of keys including a public key and a private key, for providing secure communication for the plurality of gateway devices 102-106 and the multiple Internet of Things devices 124-138. Optionally, the asymmetric cryptographic system includes a random number generator to generate security credentials for the gateway devices 102-106 and the Internet of Things devices 124-138. Optionally, the gateway devices 102-106 and the Internet of Things devices 124-138 each includes random number generator arranged locally therein. Subsequently, the random number generators generate distinct pair of keys (including the public and private keys) for the gateway devices 102-106 and each of the Internet of Things devices 124-138. Optionally, the random number generator is used as part of a key-agreement protocol for generating the security credentials. Optionally, the gateway device 102 and the Internet of Things device 124 communicate using the asymmetric cryptographic system. In such instance, the gateway device 102 will combine its own private key with the public key of the Internet of Things device 124 and the Internet of Things device 124 will combine its own private key with the public key of the gateway device 102. In such instance, the gateway device 102 and the Internet of Things device 124 is operable to obtain keys that are mutually identical. In such instance, the gateway device 102 and the Internet of Things device 124 may use their individual keys that are identical to each other to encrypt the data to be sent and decrypt the data that is received. Optionally, the commutations between the security entity 110, and the gateway devices 102-106 is configured in a similar manner as the aforesaid communication between the gateway device 102 and the Internet of Things device 124. Additionally, the communication between the gateway devices 102 and the Internet of Things devices 126 and 128; the gateway devices 104 and the Internet of Things devices 130 and 132; and the gateway devices 106 and the Internet of Things devices 134, 136 and 138 is configured in the similar manner as the aforesaid communication between the gateway device 102 and the Internet of Things device 124. Optionally, the key-agreement protocol is Diffie-Hellman protocol and/or Elliptic-curve Diffie-Hellman protocol. Optionally, the key-agreement protocol is Rivest-Shamir-Adleman (RSA). It may be appreciated that at least one of the aforesaid algorithm is used to generate the identical keys (symmetrical keys) used for the encryption and decryption of the communications between the gateway devices 102-106 and the Internet of Things devices 124-138.

According to the present disclosure, each of the Internet of Things devices 124-138 and each gateway device 102-106 include a data store. Throughout the present disclosure, the term “data store” relates to a volatile or persistent medium, such as an electrical circuit, magnetic disk, virtual memory or optical disk in which, digital information, data and/or software is stored. Optionally, the data store is (such as the data stores 112, 116 and 120 of the plurality of gateway devices 102-106, and data stores 140-154 of the multiple Internet of Things devices 124-138) a programmable hardware. Optionally, the data store (such as the data stores 112, 116 and 120, and the data stores 140-154) is a non-volatile memory device. Optionally, the non-volatile memory device is a non-volatile mass storage device such as physical storage media. Optionally the data store (such as the data stores 112, 116 and 120 of the plurality of gateway devices 102-106, and data stores 140-154 of the multiple Internet of Things devices 124-138) includes, but is not limited to, Read-Only Memory (ROM), Random-Access Memory (RAM), dynamic RAM (DRAM), Double-Data-Rate DRAM (DDR-DRAM), Synchronous DRAM (SDRAM), Static RAM (SRAM), Programmable ROM (PROM), Erasable Programmable ROM (EPROM), Electrically Erasable Programmable ROM (EEPROM), Flash Memory, Polymer Memory (e.g., ferroelectric polymer memory), Ovonic Memory, Phase Change or Ferroelectric Memory, Silicon-Oxide-Nitride-Oxide-Silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). Furthermore, in a scenario wherein computing system is distributed, the memory device may encompass processing and/or storage capability in the distributed manner. The multiple Internet of Things devices 124-138 include data stores 140-154. Optionally, the Internet of Things device 124 includes the data store 140, the Internet of Things device 126 includes the data store 142, the Internet of Things device 128 includes the data store 144, the Internet of Things device 130 includes the data store 146, the Internet of Things device 132 includes the data store 148, the Internet of Things device 134 includes the data store 150, the Internet of Things device 136 includes the data store 152, and the Internet of Things device 138 includes the data store 154. The plurality of gateway devices 102-106 includes data stores 112, 116 and 120. Optionally, the gateway device 102 includes the data store 112, the gateway device 104 includes the data store 116, and the gateway device 106 includes the data store 120.

The data store of each Internet of Things device 124-138 and each gateway device 102-106 is configured to store its own private key and a digital certificate signed by a root of trust. Optionally, data stores of each Internet of Things device 124-138 and each gateway device 102-106 are configured to include a specific area to store the private key and digital certificates signed by a root of trust. Furthermore, the specific area of the data stores of each Internet of Things device 124-138 and each gateway device 102-106 is a secure area (such as an area in the memory that has restricted access). Optionally, the data store 140 is operable to store the private key of the Internet of Things device 124 and the digital certificates for the Internet of Things device 124 signed by the root of trust, the data store 142 is operable to store the private key of the Internet of Things device 126 and the digital certificates for the Internet of Things device 126 signed by the root of trust, the data store 144 is operable to store the private key of the Internet of Things device 128 and the digital certificates for the Internet of Things device 128 signed by the root of trust, the data store 146 is operable to store the private key of the Internet of Things device 130 and the digital certificates for the Internet of Things device 130 signed by the root of trust, the data store 148 is operable to store the private key of the Internet of Things device 132 and the digital certificates for the Internet of Things device 132 signed by the root of trust, the data store 150 is operable to store the private key of the Internet of Things device 134 and the digital certificates for the Internet of Things device 134 signed by the root of trust, the data store 152 is operable to store the private key of the Internet of Things device 136 and the digital certificates for the Internet of Things device 136 signed by the root of trust, and the data store 154 is operable to store the private key of the Internet of Things device 138 and the digital certificates for the Internet of Things device 138 signed by the root of trust. In an example, the Internet of Things device 124 includes a private key ‘D’ for securely transmitting data with other devices (such as the gateway device 102) and digital certificate ‘AB’ for device authentication while performing the secure communication. In such instance, the data store 140 may be operable to store the private key ‘D’ and the digital certificate ‘AB’. In such instance, the Internet of Things device 124 may be operable to use the private key ‘D’ to decrypt data provided to the Internet of Things device 124 by the gateway device 102 in the secure communication. In an example, the Internet of Things device 126 may include a private key ‘F’ for securely transmitting data with other devices (such as the gateway device 102) and digital certificate ‘CD’ for device authentication while performing the secure communication. In such instance, the data store 142 may be operable to store the private key ‘F’ and the digital certificate ‘CD’. In such instance, the Internet of Things device 126 may be operable to use the private key ‘F’ to decrypt data provided to the Internet of Things device 126 by the gateway device 102 in the secure communication. In an example, the Internet of Things device 128 may include a private key ‘H’ for securely transmitting data with other devices (such as the gateway device 102) and digital certificate ‘EF’ for device authentication while performing the secure communication. In such instance, the data store 144 may be operable to store the private key ‘H’ and the digital certificate ‘EF’. In such instance, the Internet of Things device 128 may be operable to use the private key ‘H’ to decrypt data provided to the Internet of Things device 128 by the gateway device 102 in the secure communication. In an example, the Internet of Things device 130 may include a private key ‘J’ for securely transmitting data with other devices (such as the gateway device 104) and digital certificate ‘GH’ for device authentication while performing the secure communication. In such instance, the data store 146 may be operable to store the private key ‘J’ and the digital certificate ‘GH’. In such instance, the Internet of Things device 130 may be operable to use the private key ‘J’ to decrypt data provided to the Internet of Things device 130 by the gateway device 104 in the secure communication. In an example, the Internet of Things device 132 may include a private key ‘L’ for securely transmitting data with other devices (such as the gateway device 104) and digital certificate ‘IJ’ for device authentication while performing the secure communication. In such instance, the data store 148 may be operable to store the private key ‘L’ and the digital certificate ‘IJ’. In such instance, the Internet of Things device 132 may be operable to use the private key ‘L’ to decrypt data provided to the Internet of Things device 132 by the gateway device 104 in the secure communication. In an example, the Internet of Things device 134 may include a private key ‘N’ for securely transmitting data with other devices (such as the gateway device 106) and digital certificate ‘KL’ for device authentication while performing the secure communication. In such instance, the data store 150 may be operable to store the private key ‘N’ and the digital certificate ‘KL’. In such instance, the Internet of Things device 134 may be operable to use the private key ‘N’ to decrypt data provided to the Internet of Things device 134 by the gateway device 106 in the secure communication. In an example, the Internet of Things device 136 may include a private key ‘P’ for securely transmitting data with other devices (such as the gateway device 106) and digital certificate ‘MN’ for device authentication while performing the secure communication. In such instance, the data store 152 may be operable to store the private key ‘P’ and the digital certificate ‘MN’. In such instance, the Internet of Things device 136 may be operable to use the private key ‘P’ to decrypt data provided to the Internet of Things device 136 by the gateway device 106 in the secure communication. In an example, the Internet of Things device 138 may include a private key ‘R’ for securely transmitting data with other devices (such as the gateway device 106) and digital certificate ‘OP’ for device authentication while performing the secure communication. In such instance, the data store 154 may be operable to store the private key ‘R’ and the digital certificate ‘OP’. In such instance, the Internet of Things device 138 may be operable to use the private key ‘R’ to decrypt data provided to the Internet of Things device 138 by the gateway device 106 in the secure communication.

Optionally, the data store 112 is operable to store the private key of the gateway device 102, the data store 116 is operable to store the private key of the gateway device 104, and the data store 120 is operable to store the private key of the gateway device 106. In an example, the gateway device 102 includes a public key ‘A1’ and a private key ‘B1’ for securely transmitting data with other devices (such as the Internet of Things device 124-128 and/or the security entity 110). In such instance, the data store 112 may be operable to store the private key ‘B1’. In such instance, the gateway device 102 may be operable to use the private key ‘B1’ to decrypt the data encrypted using the public key ‘A1’ of the gateway device 102. In an example, the gateway device 104 includes a public key ‘A2’ and a private key ‘B2’ for securely transmitting data with other devices (such as the Internet of Things device 130 and 132 and/or the security entity 110). In such instance, the data store 116 may be operable to store the private key ‘B2’. In such instance, the gateway device 104 may be operable to use the private key ‘B2’ to decrypt the data encrypted using the public key ‘A2’ of the gateway device 104. In an example, the gateway device 106 includes a public key ‘A3’ and a private key ‘B3’ for securely transmitting data with other devices (such as the Internet of Things device 134-138 and/or the security entity 110). In such instance, the data store 120 may be operable to store the private key ‘B3’. In such instance, the gateway device 106 may be operable to use the private key ‘B3’ to decrypt the data encrypted using the public key ‘A3’ of the gateway device 106.

Throughout the present disclosure, the term “digital certificate” relates to any type or form of electronic document used to verify identity of a unit (such as any one of the gateway device and/or of the Internet of Things devices). The digital certificate is a device digital certificate. Optionally, the digital certificate is operable to accomplish this by using a digital signature provided by a Certificate Authority (e.g., a root of trust) to bind the public half of an asymmetric cryptographic key pair (such as the public key) associated with the unit with information that uniquely identifies the unit. Examples of digital signature include, without limitation, Transport Layer Security (TLS) certificates, Secure Sockets Layer (SSL) certificates (including Extended Validation SSL (EV SSL) certificates, X509 certificates, Organization Validation SSL (OV SSL) certificates, and Domain Validation SSL (DV SSL) certificates), and the like. Optionally, the digital certificates are operable to facilitate secure connections between the gateway device 102-106 and the Internet of Things device 124-138.

Furthermore, the digital certificate is provided by a root of trust (explained herein later in details). Furthermore, the root of trust is operable to generate and provide the digital certificates for the gateway devices 102-106 and the Internet of Things devices 124-138.

Additionally, the digital certificates include certificate status that is used to refer to the state and/or condition of the digital certificate (and/or a gateway device and an Internet of Things device as it relates to a gateway device and/or an Internet of Things device). Examples of certificate status include, but are not limited to, whether a unit (such as any one of the gateway device and/or of the Internet of Things devices) currently employs a digital certificate, whether a unit employs a particular type of digital certificate, whether a digital certificate is properly configured, whether a third-party trust seal or indicator is properly configured, whether a digital certificate has expired or is about to expire, and/or any other state or condition related to a digital certificate.

Throughout the present disclosure, the term “root of trust” relates to a set of instructions that is hosted and executed by a programmable component such as the security entity 110. Optionally, the root of trust supports system verification, software and data integrity, and keeps keys and critical data confidential. For example, the instruction, corresponding to the root of trust may be connectivity or interface control, secure boot update, encryption key management, service discovery, secure storage, digital certificate verification, peer access control, threat intelligence, trusted install service, attestation services, or the like. Optionally, the root of trust is associated with processes that are immutable and resistant to attack, and it works in conjunction with other system elements to ensure system security.

Optionally, the root of trust can be implemented as a hardware root of trust. Optionally, the security entity 110 is the root of trust. Optionally the root of trust is implemented as the security entity 110 in the distributed management system 100. Optionally, the root of trust is configured to operate as a trust anchor in the distributed management system 100. Furthermore, the root of trust is operable to provide for a variety of secure operations, such as, for example, trusted boot, task isolation, assignment of I/O resources to a unique container, attestation or secure discovery, introspection, trusted storage of data and/or keys, trusted I/O for sensing and/or control, cryptographic operations, cryptographic acceleration, key agreement protocols, secure channel connectivity and the likes. Optionally, the root of trust is operable to generate the device digital certificate that is used to determine a chain of trust among the connected units (such as the plurality of gateway devices 102-106 and the multiple Internet of Things devices 124-138). A common root of trust is configured to sign all the digital certificates. Optionally, the digital certificates of the plurality of gateway devices 102-106 and the multiple Internet of Things devices 124-138 are signed by a common root of trust. Optionally, the root of trust implemented as the security entity 110 is operable to sign the digital certificates used to authenticate the plurality of gateway devices 102-106 and the multiple Internet of Things devices 124-138.

Optionally, the security entity 110 comprises a server. Throughout the present disclosure, the term “server” relates to a structure and/or module that include programmable and/or non-programmable components configured to store, process and/or share information. Optionally, the server includes any physical or virtual computational entity capable of enhancing information to perform various computational tasks. Optionally, the security entity 110 comprising the server is operable to perform different tasks and/or provide services for controlling the plurality of gateway devices 102-106. Optionally, the server may be operable to store security information related to the plurality of gateway devices 102-106 connected to the server. In an example, a server may be operable to provide a service of authenticating the plurality of gateway devices 102-106 and the multiple Internet of Things devices 124-138. In such an instance, the server performing the authentication is activated when a gateway device of the plurality of gateway devices 102-106 requests connection to the server. In another example, the server may provide a service of data collection from the plurality of gateway devices 102-106 connected with the server of the security entity 110. Furthermore, the server performing the data collection service from the plurality of gateway devices 102-106 may remain continuously functional. In such instance, the server may be operable to perform analysis on the data acquired from the plurality of gateway devices 102-106.

Optionally, the security entity 110 comprises a Subscriber Identity Module (SIM) card. The term “Subscriber Identity Module” relates to memory that may be an integrated circuit or embedded into a removable card, and that stores an International Mobile Subscriber Identity (IMSI), related key, and/or other information used to identify and/or authenticate a device (such as the security entity 110) operating within the digital environment (such as the distributed management system 100) and enable a communication service with the distributed management system 100. Optionally, the Subscriber Identity Module (SIM) card is available in a plurality of formats. Optionally, the Subscriber Identity Module (SIM) card is in an embedded format. Optionally, the Subscriber Identity Module (SIM) card is operable to be used for machine to machine (M2M) applications, such as telemetry, industrial automation, supervisory control and data acquisition (SCADA), and the likes. Optionally, the Subscriber Identity Module (SIM) card denotes an application, i.e., software.

The data store 112, 116 and 120 of each gateway device 102-106 stores addresses of each of the Internet of Things devices 124-138 that it manages, and the data store 140-154 of each Internet of Things device 124-138 stores a digital certificate of the common root of trust. In operation, the gateway device 102 is configured to manage the Internet of Things devices 124-128; the gateway device 104 is configured to manage the Internet of Things devices 130 and 132; the gateway device 106 is configured to manage the Internet of Things devices 134-138. In such instance, the data store 112 of the gateway device 102 is configured to store the addresses of the Internet of Things devices 124-128; the data store 116 of the gateway device 104 is configured to store the addresses of the Internet of Things devices 130 and 132; the data store 120 of the gateway device 106 is configured to store the addresses of the Internet of Things devices 134-138. Optionally, the addresses of each of the Internet of Things devices 124-138 include the media access control (MAC) address, Internet Protocol (IP) address, Bluetooth identifier (ID) and the likes. Optionally, the gateway devices 102-106 is operable to use the addresses to locate the the Internet of Things devices 124-138 to locate.

Optionally, in a data communication (such as ‘UV’) wherein, the gateway device 102 is a sender and the Internet of Things device 124 is a receiver. The Internet of Things device 124 includes a media access control (MAC) address (such as media access control (MAC) address ‘MLN’). In such instance, the gateway device 102 uses the media access control (MAC) address ‘MLN’ to locate the the Internet of Things device 124. Moreover instance, the gateway device 102 is operable to encrypt the data using a key ‘OP1’ generated by the aforesaid asymmetric cryptographic system. Furthermore, the encrypted data may include instruction related to a task to be performed on the Internet of Things device 124, and the digital certificate of the gateway device 102 signed by the common root of trust. Additionally, the Internet of Things device 124 is operable to use the digital certificate of the common root of trust to authenticate the gateway device 102. Moreover, the Internet of Things device 124 is operable to verify if the digital certificate of the gateway device 102 is signed by the common root of trust. Furthermore, the digital certificate of the gateway device 102 is compared to the digital certificate of the common root of trust provided by the common root of trust to the Internet of Things device 124. It may be appreciated that a data communication between the gateway device 102 and the Internet of Things device 126 and 128; the gateway device 104 and the Internet of Things device 130 and 132; and the gateway device 106 and the Internet of Things device 134-138 is facilitated in the similar manner.

The gateway devices 102-106 is operable to connect to the security entity 110 to obtain a gateway device digital certificate (such as the device digital certificate), signed by the root of trust (i.e. the security entity 110), and permission to perform tasks on the Internet of Things device. A gateway device 102 of the plurality of gateway devices 102-106 is configured to include an interface 108 for connecting to the security entity 110. Throughout the present disclosure, the term “interface” relates to an arrangement of interconnected programmable and/or non-programmable components that are configured to facilitate data communication between one or more electronic devices (such as the security entity 110 and the gateway devices 102-106), whether available or known at the time of filing or as later developed. The data connection between the security entity 110 and the gateway devices 102-106 are provided using Wi-Fi, Universal Mobile Telecommunications System (UMTS), Ethernet, Low-Power Wide-Area Network (LPWAN), Satellite or other digital cellular technology. Furthermore, the interface 108 may include, but is not limited to, a hybrid peer-to-peer network, Local Area Network (LAN), Radio Access Network (RAN), Metropolitan Area Network (MAN), Wide Area Network (WAN), Low Powered Wide Area Network (LPWAN), all or a portion of a public network such as a global computer network known as Internet, a private network, a cellular network and any other communication system or systems at one or more locations. Additionally, the interface 108 includes wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed. Moreover, the interface 108 may be implemented using various protocols such as, TCP/IP, IPX, AppleTalk, IP-6, NetBIOS, OSI, any tunnelling protocol (e.g. IPsec, SSH), or any number of existing or future protocols. Optionally, the interface 108 is a high-speed data communication channel. Furthermore, it may be appreciated that the gateway devices 102, 104, and 106 are configured to operate in mutually similar manner. Optionally the security entity 110 is shared with other gateway devices, i.e. the resources of the security entity 110 are shared by the gateway devices 102, 104, and 106.

The gateway device 102 of the plurality of gateway devices 102-106 is configured to include a device interface 156 for connecting to one or more Internet of Things devices 124-128. Furthermore, the gateway device 104 includes the device interface 158 for connecting to one or more Internet of Things devices 130 and 132, and gateway device 106 includes the device interface 160 for connecting to one or more Internet of Things devices 134-138. Optionally, the device interfaces 156-160 are mutually similar. Optionally, the device interfaces 156-160 are low bandwidth radio communication interfaces that are capable of transferring from a few 100 bps, to a few 10 kbps. Optionally, the device interfaces 156-160 are long range low bandwidth radio communication interface. Furthermore, the device interfaces 156-160 enable low data rate wireless communications to be made over long distances. Examples of such long range low bandwidth radio communication interfaces may include, but are not limited to LoRa, SigFox or similar Low-Power Wide-Area Network (LPWAN), and combinations thereof. Optionally, the device interfaces 156-160 are operable to ensure basic data transmission. Optionally, the data connection between the plurality of gateway devices 102-106 and the multiple Internet of Things devices 124-138 are provided by the device interfaces 156-160 respectively. Optionally, device interfaces 156-160 include, but are not limited to Low-Power Wide-Area Network (LPWAN) or other wireless area network technology, such as wireless personal area network technology. In an example, wireless personal area network technology may include INSTEON®, IrDA®, Wireless USB®, Bluetooth®, Bluetooth Low Energy (BLE), Near-field communication (NFC), Z-Wave®, ZigBee®, Body Area Network and so forth. Optionally, the device interfaces 156-160 are capable of facilitating major operations such as firmware upgrade, complete device reconfiguration and so forth.

The gateway device 102 of the plurality of gateway devices 102-106 is configured to include processing means 114. Furthermore, the gateway device 104 includes the processing means 118, and the gateway device 106 includes the processing means 122. It may be appreciated that the processing means 118 and the processing means 122 are similar to the processing means 114, and are configured to operate in similar manner as the processing means 114. Throughout the present disclosure, the term “processing means” as used herein, relate to programmable and/or non-programmable components configured to execute one or more software application for storing, processing and/or sharing data and/or a set of instructions. Optionally, the processing means 114, 118, and 122 includes one or more data processing facilities for storing, processing and/or sharing data and/or set of instructions. Furthermore, the processing means 114, 118, and 122 include hardware, software, firmware or a combination of these, suitable for storing and processing various information and services accessed by the one or more devices (such as the gateway device 106). Optionally, the processing means 114, 118, and 122 include functional components, for example, a processor, a memory, and so forth. Optionally, the processing means 114, 118, and 122 are configured to analyse and process the device digital certificate provided by the security entity 110. Optionally, the processing means 114, 118, and 122 are configured to analyse, process and execute the permission to perform tasks on the Internet of Things devices 124-138 provided by the security entity 110, for the respective gateway devices 102-106. Optionally, the processing means 114, 118, and 122 are configured to analyse, process and authenticate the communication of the respective gateway devices 102-106 with the respective Internet of Things devices 124-138.

The processing means 114,-122 of the gateway devices 102-106 are configured to establish through the interface 108 the connection to the security entity 110. Optionally, the connections between the security entity 110 and the gateway devices 102-106 can be established in various manners through the interface 108. In an example, the connection may be a two-way communication channel that is established directly between the security entity 110 and the gateway devices 102-106. In another example, the security entity 110 may be hosted in the cloud computing architecture. In such an instance, the gateway devices 102-106 may be configured to initiate the communication with the security entity 110 via the interface 108. The processing means 114-122 are configured to receive security credentials (such as the device digital certificates or a signed concise binary object representation object) over the connection from the security entity 110. Optionally, the security entity 110 is operable to provide the gateway devices 102-106 with the necessary resources via the interface 108. Optionally, the security entity 110 provides the gateway devices 102-106 with the device digital certificate signed by the root of trust. Additionally, the device digital certificate enables the plurality of gateway devices 102-106, to obtain control of the multiple Internet of Things devices 124-138. Furthermore, the digital certificates included in the security credentials are used to delegate rights by the security entity 110 to the gateway devices 102-106.

The processing means 114-122 are configured to receive from the security entity 110 assignment of tasks for the gateway device 102-106 to perform on the one or more Internet of Things devices 124-138. Optionally, the assignment of tasks provided by the security entity 110 to the gateway devices 102-106 is the permissions of performing task on the multiple Internet of Things devices 124-138. Optionally, each gateway device 102-106 is authorised by the root of trust (i.e. the security entity 110) to perform tasks on the Internet of Things devices 124-138 that it manages. The root of trust (i.e. the security entity 110) uses the digital certificate to provide the gateway device 102-106 with the tasks to be performed on the multiple Internet of Things devices 124-138. Furthermore, for each gateway device 102-106 the digital certificate signed by the root of trust (i.e. the security entity 110) indicates the tasks that the gateway devices 102-106 are authorised to perform on the Internet of Things devices 124-138 that it manages. Optionally, the security entity 110 provides the gateway device 102 with the permissions of performing task on the Internet of Things devices 124-128. Furthermore, the permissions of performing task can be implemented as the permissions for management control of the Internet of Things devices 124-128. Optionally, the permissions include permission to modify firmware of the Internet of Things device 124-128. Optionally, the security entity 110 provides the gateway device 104 with the permissions of performing task on the Internet of Things devices 130 and 132. Furthermore, the permissions of performing task can be implemented as the permissions for management control of the Internet of Things devices 130 and 132. Optionally, the permissions include permission to modify firmware of the Internet of Things device 130 and 132. Optionally, the security entity 110 provides the gateway device 106 with the permissions of performing task on the Internet of Things devices 134-138. Furthermore, the permissions of performing task can be implemented as the permissions for management control of the Internet of Things devices 134-138. Optionally, the permissions include permission to modify firmware of the Internet of Things device 134-138. Optionally, the permissions can be configured to permit the gateway devices 102-106 to perform plurality of tasks on the Internet of Things devices 124-138, such as, rebooting, backup data, reconfigure to a previous device state and the likes. Optionally, the permissions of performing tasks are cryptographic operations.

The gateway devices 102-106 connect with the Internet of Things device 124-138 after it receives the gateway device digital certificate (i.e. the device digital certificate) and permission to perform tasks on the Internet of Things device 124-138 from the security entity 110. Furthermore, the gateway devices 102-106 establish a data connection with the one or more Internet of Things devices 124-138. Optionally, the data connection between the gateway devices 102-106 and the Internet of Things devices 124-138 is formed by the device interfaces 156-160 respectively. The gateway device 102 establishes the data connection with multiple Internet of Things devices 124-128 via the device interface 156, the gateway device 104 establishes the data connection with multiple Internet of Things devices 130-132 via the device interface 158, and the gateway device 106 establishes the data connection with multiple Internet of Things devices 134-138 via the device interface 160.

Optionally, one of the plurality of gateway devices, such as the gateway device 104, provides a master clock to which the Internet of Things devices 124-138 and other gateway devices 102-106 are synchronised. Optionally, the master clock of the gateway device 104 is configured to perform clock synchronization with the gateway device 102 and 106, and the Internet of Things devices 124-138. Optionally, the gateway device 104 synchronizes with the gateway device 102 and 106 and the Internet of Things devices 124-138 in order to chronologically update event data in the data stores (such as the data store 112, 116, and 120 of the gateway devices 102-106 and the data stores 140-154 of the Internet of Things devices 124-138). Optionally, the clock synchronization is operable to enable the gateway device 102 and 106, and the Internet of Things devices 124-138 to operate independently. Optionally, the clock synchronization can be implemented using various protocols, such as Network Time Protocol (NTP). Optionally, the gateway device 102-106, and the Internet of Things devices 124-138 are configured to periodically synchronize its clock with the master clock after a specific time period.

The gateway devices 102-106 use the Internet of Things device's 124-138 public key and the gateway device digital certificate to obtain management control of the Internet of Things devices 124-138. Optionally, the gateway device of anyone of the plurality of the gateway devices 102-106 is operable to use the specific public key of the specific Internet of Things device of the multiple Internet of Things devices 124-138 for obtaining management control of the Internet of Things device. For example, Internet of Things device 124 includes a public key ‘C’ and the gateway device 102 is configured to obtain management control of the Internet of Things device 124. In such an instance, the gateway device 102 is configured use the public key ‘C’ of the Internet of Things device 124 to obtain management control of the Internet of Things device 124. Optionally, the gateway device digital certificate is the device digital certificate provided by the root of trust (i.e. the security entity 110). Furthermore, the security entity 110 provides individual device digital certificate for each of the plurality of gateway devices 102-106. Optionally, the each of the plurality of gateway devices 102-106 is operable to use the individual digital certificate for obtain management control of the Internet of Things devices 124-138.

The gateway devices 102-106 are configured to perform assigned tasks on the one or more Internet of Things devices 124-138 asynchronously. Optionally, the gateway devices 102-106 are operable to communicate with and control the multiple Internet of Things devices 124-138 independently. Optionally, the gateway devices 102-106 are operable to determine a time frame for performing tasks on the multiple Internet of Things devices 124-138. In an example, the gateway device 102 may be operable to perform a process of modifying the firmware on the Internet of Things devices 124-128 monthly. Furthermore, the gateway device 104 may be operable to perform a process of modifying the firmware on the Internet of Things devices 130 and 132 weekly. In another instance, the gateway device 106 may be operable to perform a process of modifying the firmware on the Internet of Things devices 134-138 in every ten days. In an example, the gateway devices 102 may be operable to perform a process of modifying the firmware on the Internet of Things device 124 monthly. In another example, the gateway device 102 may be operable to perform a process of modifying the firmware on the Internet of Things device 126 weekly. In yet another example, the gateway device 102 may be operable to perform a process of modifying the firmware on the Internet of Things device 128 in every ten days.

The gateway devices 102-106 are configured to receive from the one or more Internet of Things devices 124-138, over a data connection (provided by the device interfaces 156-160), event data relating to the one or more Internet of Things devices 124-138. Optionally, the processing means 114, 118, and 122 of the gateway devices 102-106 are configured to receive event data relating to the one or more Internet of Things devices 124-138. Optionally, the data related to the activities performed by the one or more Internet of Things devices 124-138 are sent to the gateway devices 102-104, via the data connection of the device interfaces 156-160. In an example, the Internet of Things device 124 may be a fitness tracker used by a user. In an example, the fitness tracker may be operable to send the data describing the body temperature of the user as event data to the gateway device 102, such as a smart phone used by the user, via the data connection of the device interface 156, such as Bluetooth®. The processing means 114 of the gateway device 102 are configured to store the received event data in the data store 112. In another example, the smart phone is operable to store the event data related to the body temperature of the user in an internal memory of the smart phone. Optionally, the received event data are stored in the data store in an event sourcing format.

Optionally, the event data of the Internet of Things devices 124-138 is the data that describes all actions performed by the Internet of Things devices 124-138. In an example, an event data related to the Internet of Things devices 124 may include the information related to provisioning of the device, when the device was added to the network, the activities performed by the device, hardware version associated with the device, firmware operating in device, version of the firmware and so forth. Optionally, the event data is stored in the database arrangement as objects. Optionally, the gateway device 102 that is configured to manage the Internet of Things devices 124 is operable to employ event sourcing to store event data related to the Internet of Things devices 124 in the database arrangement. Optionally, each event is created with a timestamp, which allows all the events to be ordered chronologically. Therefore, in an event wherein a task is performed, current state of each object can be determined by compiling all the events related to the given object starting with its creation. Therefore, the database arrangement is capable of showing the current states of objects.

The gateway device 102-106 is configured to store the received event data in the data store 112, 116 and 120. The event data in the data store 112, 116 and 120 relates to the task performed by the multiple Internet of Things devices 124-138. Optionally, the data store 112, 116 and 120 of each gateway device 102-106 records tasks performed on, and data provided by the Internet of Things devices 124-138 that it manages. Optionally, the gateway device 102 is operable to store in the data store 112 the event data related to the Internet of Things devices 124-128, and the task performed by the gateway device 102 on the Internet of Things devices 124-128. Similarly, the gateway device 104 is operable to store in the data store 116 the event data related to the Internet of Things devices 130 and 132, and the task performed by the gateway device 104 on the Internet of Things devices 130 and 132, and the gateway device 106 is operable to store in the data store 120 the event data related to the Internet of Things devices 134-138 and the task performed by the gateway device 106 on the Internet of Things devices 134-138. Optionally, the processing means 114, 118, and 122 of the gateway device 102-106 are configured to transfer to the security entity 110, over the interface 108, the event data relating to the one or more Internet of Things devices 124-138 from the respective data stores 112, 116 and 120. In an example, the event data related to body temperature of a user that is stored in the data store, such as an internal memory of the smart phone may be transferred to the security entity 110, over the network connection such as Radio Access Network (RANs).

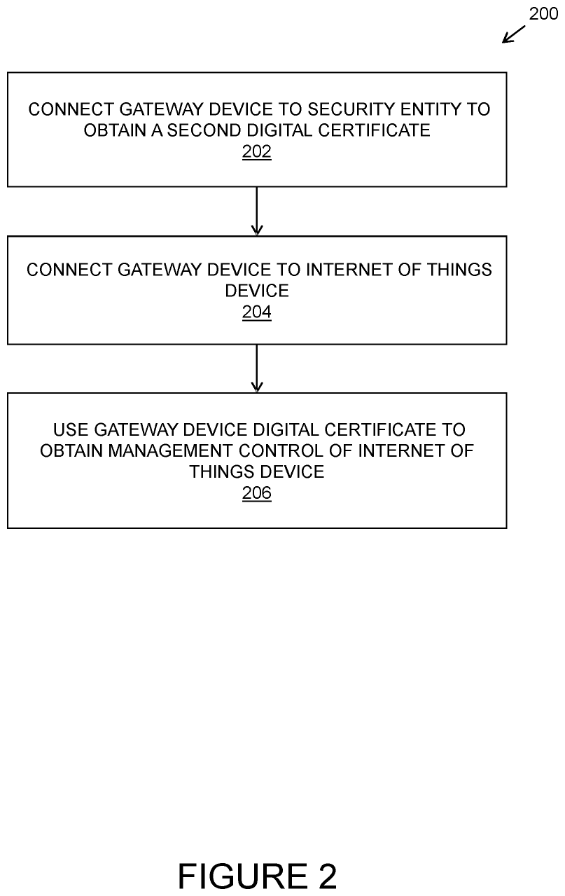

Referring to FIG. 2, there are shown steps of a method 200, for a gateway device to obtain management control of an Internet of Things device, in accordance with different embodiment of the present disclosure. At step 202 the gateway device is connected to a security entity to obtain a gateway device digital certificate signed by a root of trust, and permission to perform tasks on the Internet of Things device. At step 204 the gateway device is connected to the Internet of Things device. At step 206 the Internet of Things device's public key and the gateway device digital certificate is used to obtain management control of the Internet of Things device.

The steps 202 to 206 are only illustrative and other alternatives can also be provided where one or more steps are added, one or more steps are removed, or one or more steps are provided in a different sequence without departing from the scope of the claims herein. For example, the security entity comprises a server. In another example, the security entity is the root of trust. In yet another example, the security entity comprises a Subscriber Identity Module card. In an example, the security entity is shared with other gateway devices. For example, the permissions include permission to modify firmware of the Internet of Things device. In another example, after obtaining control of the Internet of Things device, the gateway device is used to modify firmware of the Internet of Things device. In another example, the gateway device receives permissions from the security entity to control multiple Internet of Things devices. In yet another example, for taking control of multiple Internet of Things devices the gateway device digital certificate and a public key of the respective Internet of Things device is used for each of the multiple Internet of Things devices. For example, the gateway device to the Internet of Things device is connected by means of LPWAN or a wireless personal area network technology.

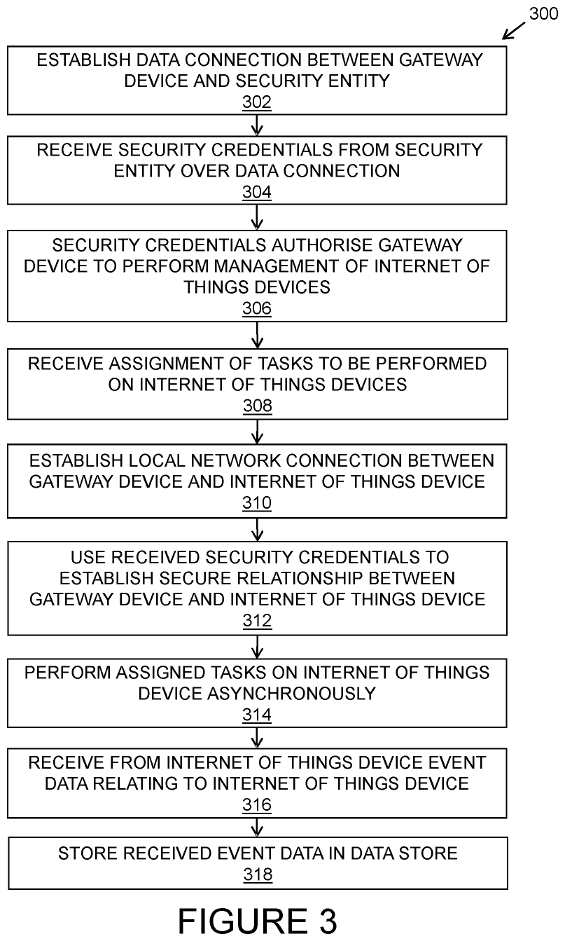

Referring to FIG. 3, there is shown steps of a method 300 for the management of Internet of Things devices, performed at a gateway device, in accordance with different embodiment of the present disclosure. At step 302, a data connection between the gateway device and a security entity is established. At step 304, security credentials from the security entity is received over the data connection. At step 306, the security credentials authorize the gateway device to perform management of Internet of Things devices. At step 308, an assignment of tasks to be performed on Internet of Things devices is received. At step 310, a local network connection is established between the gateway device and an Internet of Things device. At step 312, the received security credentials are used to establish a secure relationship between the gateway device and the Internet of Things device. At step 314, assigned tasks on the Internet of Things device are performed asynchronously. At step 316, event data relating to the Internet of Things device is received from the Internet of Things device, over the local network connection. At step 318, the received event data is stored in a data store.

The distributed management system for Internet of Things devices of the present disclosure provides an arrangement with improved efficiency for controlling the Internet of Things devices. The distributed management system enables independent functioning of the plurality of gateway devices and the multiple Internet of Things devices. Beneficially, such system remains functional in the event wherein one unit (such as a gateway device and/or an Internet of Things device) collapses and stops functioning. Furthermore, the system provides for the management of the Internet of Things devices locally, i.e. the system includes the gateway device that remains in close proximity of the Internet of Things devices. Beneficially, such arrangement provides an easier management of the Internet of Things devices. Furthermore, the system uses asymmetrical cryptography for communication. Beneficially, such arrangement allows for a secure data communication. Additionally, the system uses roots of trust. Beneficially, such arrangement allows for secure access to the units in the network.

Alternative to, or in addition to, the gateway devices 102 to 106 being authenticated and authorised to communicate with deployed devices, such as Internet of Things devices 124 to 138, users of the gateway devices 102 to 106 may be authenticated using an identity access management (IAM) process 103 and subsequently authorised to communicate with the Internet of Things devices 124 to 138 using a secure device access (SDA) process 105. The IAM process 103 and SDA process 105 are carried out on the security entity 110, which may comprise one or more servers which may be hosted in a cloud computing architecture. The users communicate with the Internet of Things devices 124 to 138 via the gateway devices 102 to 106.

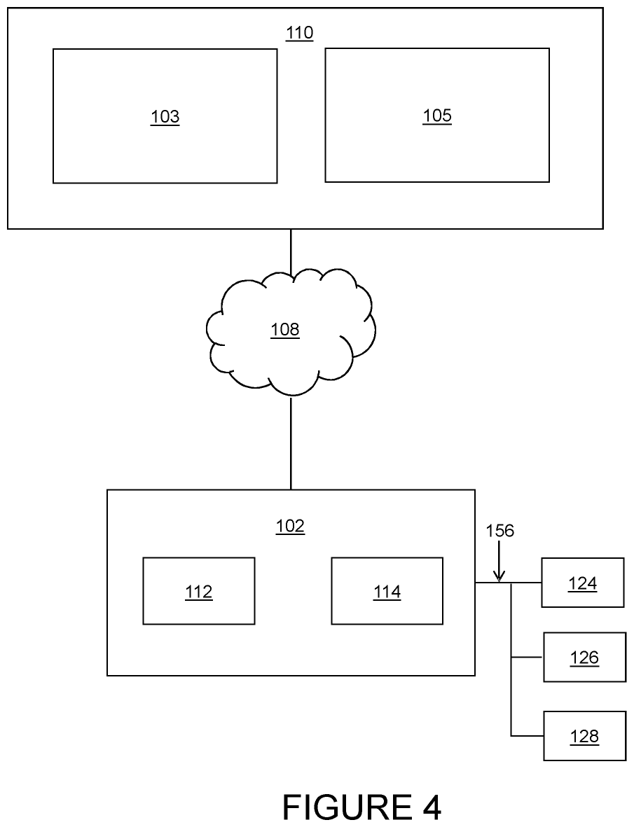

FIG. 4 shows an example of the arrangement for authenticating and authorising a user of the gateway device 102 to communicate with the Internet of Things devices 124, 126, 128. It will be understood that similar arrangements may be provided for the same or other users of the other gateway devices 104, 106 in the distributed management system 100.

The gateway device 102 comprises a proxy application to enable the gateway device 102 to communicate with the security entity 110, via interface 108, and with the Internet of Things devices 124, 126, 128, via interface 156. The Internet of Things devices 124, 126, 128 comprise a client application to enable the Internet of Things devices 124, 126, 128 to communicate with the gateway device 102, for example, with the proxy application on the gateway device 102.

The gateway device 102 is configured to send login credentials for the user to the security entity 110. The security entity 110 is configured to receive login credentials for the user from the gateway device 102. For example, the login credentials may be provided in the form of a password, two-factor authentication, multi-factor authentication, an API key or other means of authentication.

Using an IAM process 103 on the security entity 110, the user may be authenticated as a user to which the security entity 110 may provide permissions to access and/or manipulate deployed devices, such as Internet of Things devices 124, 126, 128, via the gateway device 102.

When a user has been authenticated by the IAM process 103, a first token is sent from the security entity 110 to the gateway device 102 as proof of authentication of the user. The gateway device 102 may then receive the first token from the security entity 110.

In order for the user to access and/or manipulate Internet of Things devices 124, 126, 128, subsequent to receiving the first token from the security entity 110, the gateway device 102 is able to request, for example via the proxy application, authorisation to access and/or manipulate Internet of Things devices 124, 126, 128 from the security entity 110.

A request to the security entity 110 may comprise a scope of access and an Internet of Things device ID or set of IDs for a set of Internet of Things devices that the user wishes to have access to via the gateway device 102. The device ID or set of device IDs defines the audience, which is the list of Internet of Things devices that the user wishes to have access to. The audience can be based on or identified by arbitrary attributes, identified by their endpoint, or identified by device IDs, device type, device location, or any other attribute identifying a group of Internet of Things devices and to which the devices themselves are aware. For example, the request may comprise IDs for Internet of Things devices 124, 126, 128, and a scope to provide a firmware update, or to update an operating parameter for each of the Internet of Things devices 124, 126, 128.

The security entity 110 is configured to receive the request from the gateway device 102. Using an SDA process 105, which may be based on the concise binary object representation (CBOR) object signing and encryption (COSE) specification, the security entity 110 checks whether the user is authorised to access and/or manipulate the Internet of Things devices 124, 126, 128, and that the user is authorised to perform the requested scope of access for those Internet of Things devices 124, 126, 128. The SDA process 105 and the IAM process 103 may exchange authentication and authorisation data for the user in order to provide secure access to the Internet of Things devices 124, 126, 128. Information may be stored in the security entity 110 relating to which users may carry out which operations. For example a device owner may be able to reboot the Internet of Things device 124, 126, 128 and update the firmware of the Internet of Things device 124, 126, 128, whereas a technician may only be able to reboot the Internet of Things device 124, 126, 128.

If the user is authorised to perform the requested scope of access for the identified Internet of Things devices 124, 126, 128, then a second token is sent from the security entity 110 to the gateway device 102 as proof of authorisation of the user. The second token can be in the form of a CBOR web token (CWT), and have an expiration date set by the SDA process 105 to a remote device owner or manager's preference. The second token may contain a copy of the public key of the gateway device 102, and be signed by the private key of the security entity 110.

Additionally an access control list (ACL) signed by the root of trust may be sent to the gateway device 102 from the security entity 110. The ACL defines the scope permissions to the Internet of Things devices 124, 126, 128. That is, the ACL defines the scope of allowable actions that the gateway device 102 is permitted to instruct the Internet of Things devices 124, 126, 128 to perform or execute.

Once the user is authorised to access and/or manipulate the Internet of Things devices 124, 126, 128, the user, via the gateway device 102, can connect to each of the Internet of Things devices 124, 126, 128 to perform suitable operations thereon. The gateway device 102 can be offline whilst accessing and/or manipulating the Internet of Things devices 124, 126, 128.

Once the user is authorised to access and/or manipulate the Internet of Things devices 124, 126, 128, the gateway device 102 requests a third token, in the form of a nonce (e.g., a unique pseudo-random number), from a particular Internet of Things device 124, 126, 128, and receives, in response, a nonce, generated by the Internet of Things device 124, 126, 128, which must be added to an operation bundle to be sent from the gateway device 102, to the Internet of Things device 124, 126, 128, in order for the Internet of Things device 124, 126, 128 to perform the actions defined by the scope of access.

In particular, the gateway device 102, via the proxy application, sends the operation bundle, comprising the nonce, the second token and the actions defined by the scope of access to the client application on the Internet of Things device 124, 126, 128. The Internet of Things device 124, 126, 128 receives the operation bundle form the gateway device 102. The second token may contain a public key of the user, so that the Internet of Things devices 124, 126, 128 can validate the authenticity of the operation bundle. The nonce may prevent or mitigate a replay attack on the Internet of Things device 124, 126, 128, since it allows the Internet of Things device 124, 126, 128 to verify that the nonce matches what is expected to verify that it received a fresh operation bundle comprising actions to be performed, and not an operation bundle that was created some time ago.

The Internet of Things devices 124, 126, 128 will only accept the second token if that second token is signed using a private key associated with the root of trust, the private key having a matching public key which is embedded in the Internet of Things devices 124, 126, 128 during initial setup of those Internet of Things devices 124, 126, 128. The private key that the second token may be signed by may be termed a trust anchor.

By using the IAM process 103 and SDA process 105, different users may be given different levels of access to the Internet of Things devices 124, 126, 128. A user may obtain the same level of access using different gateway devices 106 in order to connect to the Internet of Things devices 124, 126, 128, since the authorisations are user specific and not specific to the gateway device 102.

The Internet of Things devices 124, 126, 128 do not need to be connected to the security entity 110 in order for the gateway device 102 to communicate with the SDA process 105 for obtaining the second token. The gateway device 102 does not need to be connected to the security entity 110 when sending operation bundles.

Whilst the security entity 110 and the Internet of Things devices 124, 126, 128 are trusted entities, the gateway device 102 may not be a trusted entity. The gateway device 102 is delegated responsibilities for instructing the Internet of Things devices 124, 126, 128 from the security entity 110. The ACL which defines the scope of allowable actions that the gateway device 102 is permitted to instruct the Internet of Things devices 124, 126, 128 to perform may therefore provide a security risk if the gateway device 102 is compromised. In particular, the gateway device 102 may need to conditionally execute instructions or select parameters based on previous responses from the Internet of Things devices 124, 126, 128, and therefore the gateway device 102 requires a broader scope of authorisation from the security entity 110 than the precise instructions that are actually executed on the Internet of Things devices 124, 126, 128.

If the gateway device 102 is compromised then it can be maliciously manipulated to change the order or sequence of the instructions provided to the Internet of Things devices 124, 126, 128. The Internet of Things devices 124, 126, 128 may still accept and carry out the instructions provided by the gateway device 102 as the instructions are still within the scope of the ACL, despite the instructions not being commensurate with the intended instructions from the security entity 110.

In order to mitigate for the potential compromise of the gateway device 102, the Internet of Things device 124, 126, 128 retains an ordered log of the instructions that it was requested to perform by the gateway device 102. The ordered log may comprise event data relating to the Internet of Things device 124, 126, 128, controlled by the gateway device 102. The Internet of Things device 124, 126, 128 further signs the log. The Internet of Things device 124, 126, 128 creates a hash value, such as a rolling hash value, generated based on each instruction as it is received and executed by the Internet of Things device 124, 126, 128.

The log is then passed via the gateway device 102 to the security entity 110, where the security entity 110 can perform a check on the log to ensure that the instructions performed by the Internet of Things device 124, 126, 128 match the instructions that were intended to be performed by the Internet of Things device 124, 126, 128.

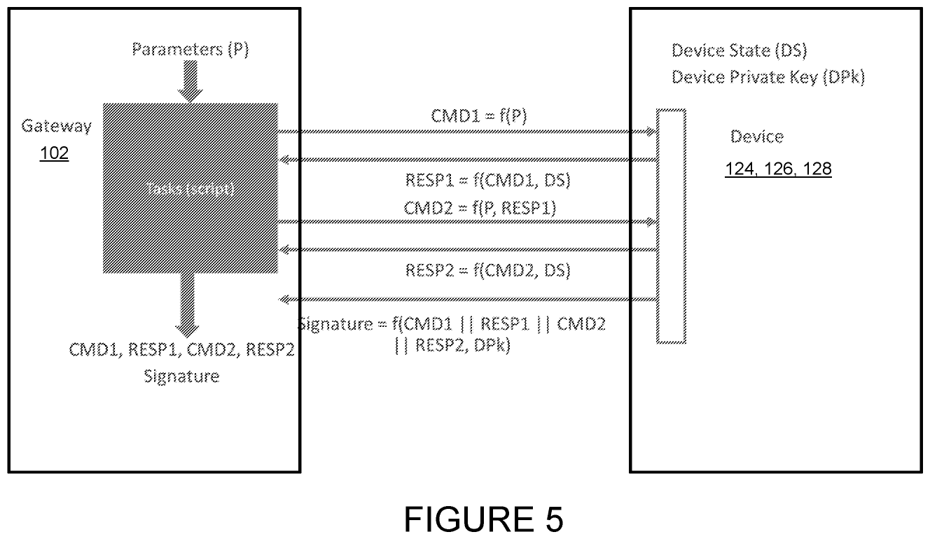

FIG. 5 illustrates the communications between the gateway device 102 and the Internet of Things device 124, 126, 128, in an example embodiment. Initially the gateway device 102 receives parameters P from the security entity 110 and transmits a first command CMD1, which is a function of the received parameters P, to the Internet of Things device 124, 126, 128.

The Internet of Things device 124, 126, 128 provides a response RESP1 to the gateway device 102, the response RESP1 being a function of the command CMD1 performed and a device state DS of the Internet of Things device 124, 126, 128.

The gateway device 102 then transmits a second command CMD2, which is a function of the received parameters P and the response RESP1, to the Internet of Things device 124, 126, 128.

The Internet of Things device 124, 126, 128 provides a second response RESP2 to the gateway device 102, the second response RESP2 being a function of the second command CMD2 performed and a device state DS of the Internet of Things device 124, 126, 128.

The Internet of Things device 124, 126, 128 further provides a signature to the gateway device 102, the signature being a function of the first command CMD1, the first response RESP1, the second command CMD2, the second response RESP2, and the private key DPk of the Internet of Things device 124, 126, 128, to form a log.

The gateway device 102 transmits the log and the commands CMD1, CMD2 and responses RESP1, RESP2 to the security entity 110. The inclusion of the Internet of Things private key DPk in the signature ensures that the information transmitted to the security entity 110 can be trusted.

Since the Internet of Things device 124, 126, 128 is trusted, the instructions sent from the gateway device 102 can be verified using the information received at the security entity 110.

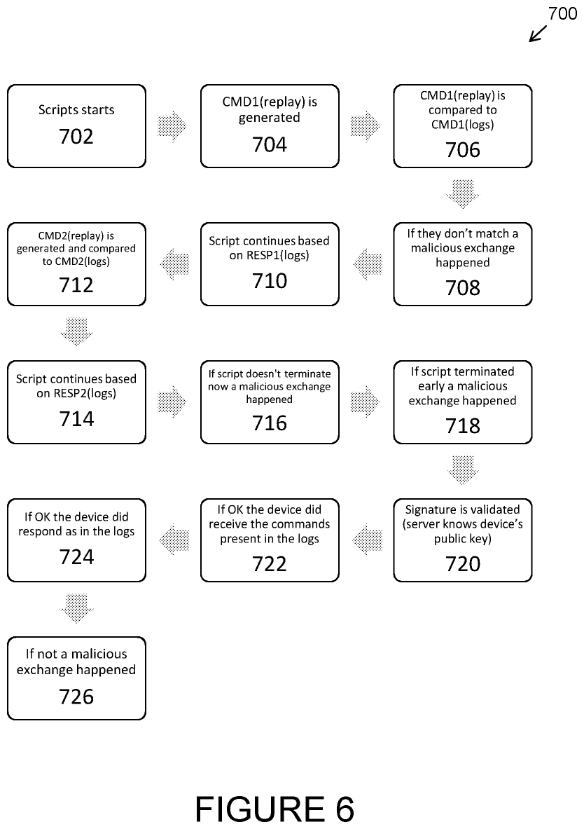

FIG. 6 then illustrates a process 700 at the security entity 110 for detecting a malicious attack on the gateway device 102. This process effectively replays the steps or blocks carried out by the gateway device 102 using the initial parameters P, the responses RESP1, RESP2 from the Internet of Things device 124, 126, 128, and contextual parameters recorded in the log, such as time of execution, or any manual steps performed by the gateway device user.

When replaying the steps or blocks carried out by the gateway device 102, the security entity 110 checks that the exact same commands are generated for execution and that there are no additional commands or missing commands.

At block 702 the script on the security entity 110 starts.

At block 704 a replay of CMD1 is generated and at block 706 the replay of CMD1 is compared to CMD1 from the log. At block 708 a malicious exchange is considered to have happened if the replay of CMD1 does not match CMD1 from the log. In such an event the Internet of Things device 124, 126, 128 may be re-instructed with the correct commands or the Internet of Things device 124, 126, 128 status can be rolled back.

At block 710 the script continues based on RESP1 from the log. At block 712 a replay of CMD2 is generated and compared to CMD2 from the log. At block 714 the script continues based on RESP2 from the log. At block 716 it is determined that if the script doesn't terminate at this point a malicious exchange happened, as the replay does not match the log, and the Internet of Things device 124, 126, 128 may then be re-instructed with the correct commands or the Internet of Things device 124, 126, 128 status can be rolled back. At block 718 it is determined that if the script terminated early then a malicious exchange happened, as the replay does not match the log, and the Internet of Things device 124, 126, 128 may then be re-instructed with the correct commands or the Internet of Things device 124, 126, 128 status can be rolled back.

At block 720 the signature is validated, the server knowing the public key of the Internet of Things device 124, 126, 128. At block 722 it is determined that if the signature is valid then the Internet of Things device 124, 126, 128 did receive the commands present in the logs, and at block 724 it is determined that if the signature is valid then the Internet of Things device 124, 126, 128 did respond as in the logs. At block 726 it is determined that if the signature is not valid then a malicious exchange happened, and the Internet of Things device 124, 126, 128 may then be re-instructed with the correct commands or the Internet of Things device 124, 126, 128 status can be rolled back.

Whilst the embodiments herein described comprise two commands CMD1, CMD2 and two respective responses RESP1, RESP2 in the communications between the gateway device 102 and the Internet of Things device 124, 126, 128, any number of commands and respective responses may be performed, including more than two commands and more than two respective responses.

In some arrangements the security entity 110 may comprise a plurality of servers, the IAM process 103 being carried out on a first server, such as an IAM server, and the SDA process 105 being carried out on a second server, such as an SDA server. In alternative arrangements the server arrangement may comprise a single server comprising the functionality of the IAM process 103 and the SDA process 105.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for a gateway device, or user of a gateway device, to obtain management control of an Internet of Things device, the Internet of Things device including a data store storing:
a private key of a private/public key pair for the Internet of Things device;
a digital certificate from a root of trust;
a gateway device, or gateway device user, digital certificate signed by a root of trust, the method comprising:
connecting the gateway device to a security entity to obtain a gateway device, or gateway device user, digital certificate, signed by the root of trust, and permission to perform tasks on the Internet of Things device;
connecting the gateway device to the Internet of Things device; and
using the gateway device's, or gateway device user's, digital certificate to obtain management control of the Internet of Things device.

2. A method as claimed in claim 1, wherein the security entity comprises a server.

3. A method as claimed in claim 1, wherein the security entity is the root of trust.

4. A method as claimed in claim 1, wherein the security entity comprises a Subscriber Identity Module card.

5. A method as claimed in claim 1, wherein the security entity is shared with other gateway devices.

6. A method as claimed in claim 1, wherein the permissions include permission to modify firmware of the Internet of Things device.

7. A method as claimed in claim 6, further comprising, after obtaining control of the Internet of Things device, using the gateway device to modify firmware of the Internet of Things device.

8. A method as claimed in claim 1, wherein the gateway device receives permissions from the security entity to control multiple Internet of Things devices.

9. A method as claimed in claim 8, further comprising taking control of multiple Internet of Things devices using for each of the multiple Internet of Things devices the gateway device digital certificate and a public key of the respective Internet of Things device.

10. A method as claimed in claim 1, wherein connecting the gateway device to the Internet of Things device is by means of LPWAN or a wireless personal area network technology.

11. A method as claimed in claim 1, wherein the server comprises an identity access management server configured to establish the authentication of a user of the gateway device and a secure device access server configured to establish an authorisation of the user of the gateway device to communicate with Internet of Things devices via the gateway device.

12. A method as claimed in claim 11, wherein the authorisation of the user of the gateway device established by the secure device access server provides a first level of authorisation allowing reboot of the Internet of Things devices.

13. A method as claimed in claim 12, wherein the authorisation of the user of the gateway device established by the secure device access server provides a second level of authorisation allowing a firmware update of the Internet of Things devices.

14. A method as claimed in claim 1, wherein the data store of the Internet of Things device further stores event data relating, at least, to tasks performed at the Internet of Things device.

15. A method as claimed in claim 14, wherein the event data is signed by the Internet of Things device.

16. A method as claimed in claim 2, wherein the server receives, from the gateway device, event data relating to Internet of Things devices controlled by the gateway device, replays the tasks at the server, compares the replayed tasks to the received event data and identifies a malicious attack if the replayed tasks do not match the received event data.

17. A distributed management system for Internet of Things devices, comprising multiple Internet of Things devices and a plurality of gateway devices, each gateway device being configured to manage a plurality of the Internet of Things devices, and each Internet of Things device and each gateway device having:
its own private/public key pair;
a data store storing its own private key and a digital certificate signed by a root of trust; wherein the digital certificates are all signed by a common root of trust; and wherein
the data store of each gateway device stores addresses of each of the Internet of Things devices that it manages, and the data store of each Internet of Things device stores a digital certificate of the common root of trust.

18. A distributed management system according to claim 17, wherein each gateway device is authorised by the root of trust to perform tasks on the Internet of Things devices that it manages.

19. A distributed management system according to claim 18, wherein for each gateway device the digital certificate signed by the root of trust indicates the tasks that the gateway device is authorised to perform on the Internet of Things devices that it manages.

20. A distributed management system according to claim 17, wherein one of the plurality of gateway devices provides a master clock to which the Internet of Things devices and other gateway devices are synchronised.

21. A distributed management system according to claim 17, wherein the data store of each gateway device records tasks performed on, and data provided by the Internet of Things devices that it manages.

22. A gateway device for managing Internet of Things devices, the gateway device comprising:
an interface for connection to a security entity;
a data store;
a device interface for connection to one or more Internet of Things devices; and
a processing means, wherein the processing means of the gateway device being configured to:
establish through the interface the connection to the security entity;
receive security credentials over the connection from the security entity;
receive from the security entity an assignment of tasks for the gateway device to perform on one or more Internet of Things devices;
establish through the device interface a data connection with the one or more Internet of Things devices;
use the received security credentials to obtain control of the one or more Internet of Things devices;
perform assigned tasks on the one or more Internet of Things devices asynchronously;
receive from the one or more Internet of Things devices, over a data connection, event data relating to the one or more Internet of Things devices; and
store the received event data in the data store.

23. A method for the management of Internet of Things devices, performed at a gateway device, the method comprising:
establishing a data connection between the gateway device and a security entity;
receiving security credentials from the security entity over the data connection;
the security credentials authorising the gateway device, or user of the gateway device, to perform management of Internet of Things devices;
receiving an assignment of tasks to be performed on Internet of Things devices;
establishing a local network connection between the gateway device and an Internet of Things device;
using the received security credentials to establish a secure relationship between the gateway device and the Internet of Things device;
performing assigned tasks on the Internet of Things device asynchronously;
receiving from the Internet of Things device, over the local network connection, event data relating to the Internet of Things device; and
storing the received event data in a data store.
